(19) United States
(12) Patent Application Publication
(10) Pub. No.: US 2025/0232388 A1
(43) Pub. Date: Jul. 17, 2025

(54) HYBRID MODEL TO OPTIMIZE THE FUNGICIDE APPLICATION SCHEDULE

(71) Applicant: BASF AGRO TRADEMARKS GMBH, Ludwigshafen (DE)

(72) Inventors: Gang ZHAO, Langenfeld (DE); Bjoern KIEPE, Köln (DE); Andreas JOHNEN, Münster (DE); Karoline EPKE, Münster (DE); Quanying ZHAO, Koeln (DE)

(21) Appl. No.: 18/850,998

(22) PCT Filed: Mar. 16, 2023
(86) PCT No.: PCT/EP2023/056780

§ 371 Date: Sep. 25, 2024

(30) Foreign Application Priority Data
Mar. 25, 2022 (EP) 22164577.3

(51) Int. Cl. G06Q 50/02; G06N 20/00; G06Q 10/00

(52) U.S. Cl. CPC G06Q 50/02; G06N 20/00; G06Q 10/00

(57) ABSTRACT

The present invention relates to fungal disease management. In order to improve fungal disease management, a computer-implemented method is provided for determining a disease progression usable for fungicide spray schedule on an agricultural field. The method comprising the step of receiving data including crop variety data, environmental data, crop management data, and location data of the agricultural field. The crop variety data relates to a crop grown or to be grown on an agricultural field. The environmental data is indicative of an environmental condition for the agricultural field. The crop management data is indicative of fungicide spray history for the agricultural field. The method further comprises the step of applying a machine-learning model to the received data to determine disease progression time-series data of a fungal disease, wherein the machine-learning model has been trained to learn the disease progression under a condition defined by crop variety data, environmental data, crop management data, and location data based on historic data collected from one or more agricultural fields. The method further comprises the step of determining, based on the determined disease progression time-series data, a disease onset date of the fungal disease.

### FIELD OF THE INVENTION

The present invention relates to fungal disease management. In particular, the present invention relates to a computer-implemented method and an apparatus for determining a disease progression usable for fungicide spray schedule on an agricultural field, and to a computer program element.

### BACKGROUND OF THE INVENTION

Fungicides are used in agriculture. Fungal diseases in plant are very diverse and affecting all parts of the plant, that is, head (e.g., common root rot, crown rot, sclerotium wilt), stem or sheath (e.g., eyespot, stem rust), leaves (e.g., leaf blight, rust, powdery mildew), spikes (e.g., ergot), and seeds (e.g., black point, carnal bunt). The common recommendation for fungicide application timing is before the start of inoculation, the primary infection.

However, the starting date of the primary infection of crop diseases may vary from season to season depending on the availability of inoculum and weather condition. Therefore, fungal disease management becomes more complex.

### SUMMARY OF THE INVENTION

There may be a need to improve fungal disease management.

The object of the present invention is solved by the subject-matter of the independent claims,
wherein further embodiments are incorporated in the dependent claims. It should be noted that
the following described aspects of the invention apply also for the computer-implemented data processing method and the apparatus, the computer program element, and the computer readable medium.

According to a first aspect of the present invention, there is provided a computer-implemented method for determining a disease progression usable for fungicide spray schedule on an agricultural field, the method comprising:
a) receiving data including:
   crop variety data relating to a crop grown or to be grown on an agricultural field;
   environmental data indicative of an environmental condition for the agricultural field;
   crop management data indicative of fungicide spray history for the agricultural field;
and
   location data of the agricultural field;
b) applying a machine-learning model to the received data to determine disease progression time-series data of a fungal disease, wherein the machine-learning model has been trained to learn the disease progression under a condition defined by crop variety data, environmental data, crop management data, and location data based on historic data collected from one or more agricultural fields; and
c) determining, based on the determined disease progression time-series data, a disease onset date of the fungal disease.

The computer-implemented method and apparatus as describe herein apply a machine-learning model to identify the primary infection-that is, the starting date of the primary infection of crop diseases.

The machine-learning model may be any appropriate model capable of determining disease progression time series data of a fungal disease. Examples of the machine-learning model may include, but are not limited to, XGB regression model, Artificial Neural Network, Recurrent Neural Network and Support Vector Regression.

The starting date of the primary infection of crop disease, also referred to as disease onset, may be used to determine the disease progression curve. For example, a process-based model may be used to simulate the interactions between disease onset date and variety susceptibility to determine the secondary infection, which will be explained in detail hereinafter.

Determining the disease onset and disease progress curves to characterize disease progress over time is essential for understanding how plant diseases develop and how disease control measures should be taken to achieve the highest efficacy of fungicide. Based on such information, a fungicide spray schedule may be determined. In this way, spray timing is set with considering the changes in disease dynamics, leading to improved treatments. For example, spray timing may be set based on the predicted risk of disease, allowing to apply fungicides when they are most effective during the growing season. In particular, the determined fungicide spray schedule may target the optimal application periods better to halt disease progress, with less chance of missing the risk periods. The optimized spray timing may have a considerable effect on the overall reduction in fungicide use, which in turn may cause less damage in agriculture, resulting in less losses of yield, quality, and profit.

According to an embodiment of the present invention, the disease onset date of the fungal disease is determined utilizing a change point detection algorithm.

According to an embodiment of the present invention, a plurality of machine-learning models are provided for two or more fungal diseases, and each machine-learning model has been trained for a single disease.

In this way, each machine-learning model is specially trained for determining the disease onset and disease progress curves to characterize progress over time for a particular fungal disease.

According to an embodiment of the present invention, the machine-learning model comprises an Xtreme Gradient Boosting (XGB) regression model.

In some examples, the model choice may be an XGB regression model tuned over a Randomized Search Cross validation. XGB is a scalable tree boosting system and can be thought of as gradient boosting with regularization. It may enable parallelized tree building, cache-aware access, sparsity awareness, and weighted quantile sketch as some of its systems optimization and algorithmic enhancements.

According to an embodiment of the present invention, the computer-implemented method further comprises d) applying a process-based model to determine an infection rate of the fungal disease after the disease onset day under a condition defined by the crop variety data, environmental data, and the location data.

In other words, a process-based model is proposed to simulate the secondary infections with processes included susceptible, exposed, infectious, and removal. Environmental factor including temperature and wetness are considered for infection rate. The variety susceptibility, fungicide and crop growth stage are also considered in the infection rate calculation. The process-based model may be used to simulate the interactions between disease onset date, variety susceptibility, and fungicide application. The infection rate of the fungal disease may be provided in form of a disease progress curve, which is preferably usable for optimizing the schedule of fungicide.

According to an embodiment of the present invention, the infection rate of the fungal disease is determined by further including a condition defined by a variety disease resistance level of the crop.

According to an embodiment of the present invention, the infection rate of the fungal disease is determined by further including a condition defined by fungicide application data including fungicide data of a fungicide product to be used and at least one planned application timing.

In other words, the process-based model may be used to simulate the interactions between disease onset date, variety susceptibility, and fungicide application. By analyzing the effects of fungicide applications on the disease progress curve, such as the curve shown in FIG. 25, it is possible to determine the fungicide spray schedule.

According to an embodiment of the present invention, the process-based model comprises a susceptible-exposed-infections-removed (SEIR) model.

According to an embodiment of the present invention, the crop variety data comprises one or more of growth stage of the crop, days after plantation, and a variety disease resistance level of the crop.

According to an embodiment of the present invention, the environmental data comprises one or more of air temperature, cloud cover, short ware radiation, long wave radiation, ice accumulation period, liquid accumulation period, relative humidity, precipitation accumulation period adjusted, snow accumulation period, and wind speed.

According to an embodiment of the present invention, the location data comprises latitude and longitude data.

According to an embodiment of the present invention, the computer-implemented method further comprises e) determining, based on the determined disease progress, a fungicide spray schedule.

In some examples, the fungicide spray schedule may comprise spray application timing data.

In some examples, the fungicide spray schedule may be provided to a farmer. The farmer then controls a sprayer to apply the fungicide according to the spray application timing data.

In some examples, a configuration file is generated based on the fungicide spray schedule. The configuration file may be loaded to a sprayer to configure the sprayer to apply the fungicide according to the spray application timing data.

According to an embodiment of the present invention, the computer-implemented method further comprises f) generating, based on the fungicide spray schedule, a configuration file preferably usable for configuring a sprayer for fungicide spray application.

According to a second aspect of the present invention, there is provided an apparatus for generating a disease progression usable for fungicide spray schedule on an agricultural field, the apparatus comprising one or more processing units to generate the application scheme, wherein the one or more processing units include instructions, which when executed on the one or more processing units, perform the method steps of any one of the preceding claims.

In general, the functionality of any one or more components of the apparatus may be implemented by any appropriate computing environment, such as personal computing environment, time sharing computing environment, distributed computing environment, cloud computing environment, and cluster computing environment.

In some examples, the apparatus is embodied as, or in, a device or apparatus, such as a server, workstation, or mobile device.

In some examples, the apparatus may be implemented with or without employing a processor, and also may be implemented as a combination of dedicated hardware to perform some functions and a processor (e.g., one or more programmed microprocessors and associated circuitry) to perform other functions.

In some examples, the apparatus may also be implemented in a distributed manner. For example, some or all units of the apparatus may be arranged as separate modules in a distributed architecture and connected in a suitable communication network.

According to a third aspect of the present invention, there is provided a computer program element comprising instructions to cause the apparatus according to the second aspect to execute the steps of method according to the first aspect and any associated example.

As used herein, the term “agricultural field” is understood to be any area in which organisms, particularly crop plants, are produced, grown, sown, and/or planned to be produced, grown or sown. The term “agricultural field” also includes horticultural fields, silvicultural fields and fields for the production and/or growth of aquatic organisms.

As used herein, the term “crop” is plant that can be grown and harvested extensively for profit or subsistence. Examples of the crop may include, but are not limited to, Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea may. Most preferred crops are: Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays. Preferred crops are crops of cereals, corn, soybeans, rice, oilseed rape, cotton, potatoes, peanuts or perennial crops.

In a preferred embodiment of this invention, by way of example, disease or plant diseases may be caused by one or more of the following agents:

Albugo spp. (white rust) on ornamentals, vegetables (e.g. A. candida) and sun-flowers (e.g. A. tragopogonis); Alternaria spp. (Alternaria leaf spot) on vegetables (e.g. A. dauci or A. porri), oilseed rape (A. brassicicola or brassicae), sugar beets (A. tenuis), fruits (e.g. A. grandis), rice, soybeans, potatoes and tomatoes (e.g. A. solani, A. grandis or A. alternata), tomatoes (e.g. A. solani or A. alternata) and wheat (e.g. A. triticina); Aphano-myces spp. on sugar beets and vegetables; Ascochyta spp. on cereals and vegetables, e.g. A. tritici (anthracnose) on wheat and A. hordei on barley; Aureobasidium zeae (syn. Kapatiella zeae) on corn; Bipolaris and Drechslera spp. (teleomorph: Cochliobolus spp.), e.g. Southern leaf blight (D. maydis) or Northern leaf blight (B. zeicola) on corn, e.g. spot blotch (B. sorokiniana) on cereals and e.g. B. oryzae on rice and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages); B. squamosa or B. allii on onion family, oilseed rape, ornamentals (e.g. B. eliptica), vines, forestry plants and wheat; Bremia lactucae (downy mildew) on lettuce; Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on corn (e.g. Gray leaf spot: C. zeae-maydis), rice, sugar beets (e.g. C. beticola), sugar cane, vegetables, coffee, soybeans (e.g. C. sojina or C. kikuchii) and rice; Cladobotryum (syn. Dactylium) spp. (e.g. C. mycophilum (formerly Dactylium dendroides, teleomorph: Nectria albertinii, Nectria rosella syn. Hypomyces rosellus) on mushrooms; Cladosporium spp. on tomatoes (e.g. C. fulvum: leaf mold) and cereals, e.g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e.g. C. sativus, anamorph: B. sorokiniana) and rice (e.g. C. miyabeanus, anamorph: H. oryzae); Colletotrichum (teleomorph: Glomerella) spp. (anthracnose) on cotton (e.g. C. gossypii), corn (e.g. C. graminicola: Anthracnose stalk rot), soft fruits, potatoes (e.g. C. coccodes: black dot), beans (e.g. C. lindemuthi-anum), soybeans (e.g. C. truncatum or C. gloeosporioides), vegetables (e.g. C. lagenarium or C. capsici), fruits (e.g. C. acutatum), coffee (e.g. C. coffeanum or C. kahawae) and C. gloeosporioides on various crops; Corticium spp., e.g. C. sasakii (sheath blight) on rice; Coryne-spora cassiicola (leaf spots) on soybeans, cotton and ornamentals; Cycloconium spp., e.g. C. oleaginum on olive trees; Cylindrocarpon spp. (e.g. fruit tree canker or young vine decline, teleomorph: Nectria or Neonectria spp.) on fruit trees, vines (e.g. C. lirio-dendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soy-beans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (formerly Phaeo-acremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e.g. E. pisi), such as cucurbits (e.g. E. cichoracearum), cabbages, oilseed rape (e.g. E. crucife-rarum); Eutypa lata (Eutypa canker or dieback, anamorph: Cytosporina lata, syn. Liber-tella blepharis) on fruit trees, vines and ornamental woods; Exserohilum (syn. Helmin-thosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxy-sporum on tomatoes, F. solani (f. sp. glycines now syn. F. virguliforme) and F. tucumaniae and F. brasiliense each causing sudden death syndrome on soybeans, and F. verticillioides on corn; Gaeumanno-myces graminis (take-all) on cereals (e.g. wheat or barley) and corn; Gibberella spp. on cereals (e.g. G. zeae) and rice (e.g. G. fujikuroi: Bakanae disease); Glomerella cingulata on vines, pome fruits and other plants and G. gossypii on cotton; Grain-staining complex on rice; Guignardia bidwellii (black rot) on vines; Gymnosporangium spp. on rosaceous plants and junipers, e.g. G. sabinae (rust) on pears; Helmintho-sporium spp. (syn. Drechslera, teleomorph: Cochliobolus) on corn, cereals, potatoes and rice; Hemileia spp., e.g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e.g. wheat or barley); Microsphaera diffusa (powdery mildew) on soybeans; Monilinia spp., e.g. M. laxa, M. fructicola and M. fructigena (syn. Monilia spp.: bloom and twig blight, brown rot) on stone fruits and other rosaceous plants; Mycosphaerella spp. on cereals, bananas, soft fruits and ground nuts, such as e.g. M. graminicola (anamorph: Zymoseptoria tritici formerly Septoria tritici: Septoria blotch) on wheat or M. fijiensis (syn. Pseudocercospora fijiensis: black Sigatoka disease) and M. musicola on bananas, M. arachidicola (syn. M. arachidis or Cercospora arachidis), M. berkeleyi on peanuts, M. pisi on peas and M. brassiciola on brassicas; Peronospora spp. (downy mildew) on cabbage (e.g. P. brassicae), oilseed rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phialophora spp. e.g. on vines (e.g. P. tracheiphila and P. tetraspora) and soybeans (e.g. P. gregata: stem rot); Phoma lingam (syn. Leptosphaeria biglobosa and L. maculans: root and stem rot) on oilseed rape and cabbage, P. betae (root rot, leaf spot and damping-off) on sugar beets and P. zeae-maydis (syn. Phyllostica zeae) on corn; Phomopsis spp. on sunflowers, vines (e.g. P. viticola: can and leaf spot) and soybeans (e.g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e.g. P. capsici), soybeans (e.g. P. megasperma, syn. P. sojae), potatoes and tomatoes (e.g. P. infestans: late blight) and broad-leaved trees (e.g. P. ramorum: sudden oak death); Plasmodiophora brassicae (club root) on cabbage, oilseed rape, radish and other plants; Plasmopara spp., e.g. P. viticola (grapevine downy mildew) on vines and P. halstedii on sunflowers; Podosphaera spp. (powdery mildew) on rosa-ceous plants, hop, pome and soft fruits (e.g. P. leucotricha on apples) and curcurbits (P. xanthii); Polymyxa spp., e.g. on cereals, such as barley and wheat (P. graminis) and sugar beets (P. betae) and there-by transmitted viral diseases; Pseudocercosporella herpotrichoides (syn. Oculimacula yallundae, O. acuformis: eyespot, teleo-morph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or ‘rotbrenner’, anamorph: Phialophora) on vines; Puccinia spp. (rusts) on various plants, e.g. P. triticina (brown or leaf rust), P. strii-formis (stripe or yellow rust), P. hordei (dwarf rust), P. graminis (stem or black rust) or P. recondita (brown or leaf rust) on cereals, such as e.g. wheat, barley or rye, P. kuehnii (orange rust) on sugar cane and P. asparagi on asparagus; Pyrenopeziza spp., e.g. P. brassicae on oilseed rape; Pyrenophora (anamorph: Drechslera) tritici-repentis (tan spot) on wheat or P. teres (net blotch) on barley; Pyricularia spp., e.g. P. oryzae (teleomorph: Magnaporthe grisea: rice blast or leaf blast) on rice and P. grisea on turf and cereals and Magnaporthe oryzae (panicle-neck blast) on rice; Pythium spp. (damping-off) on turf, rice, corn, wheat, cotton, oilseed rape, sunflowers, soy beans, sugar beets, vegetables and various other plants (e.g. P. ultimum or P. aphani-dermatum) and P. oligandrum on mushrooms; Ramularia spp., e.g. R. collo-cygni (Ramularia leaf spots, Physiological leaf spots) on barley, R. areola (teleomorph: Mycosphaerella areola) on cotton and R. beticola on sugar beets; Rhizoctonia spp. on cotton, rice, potatoes, turf, corn, oilseed rape, potatoes, sugar beets, vegetables and various other plants, e.g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis and R. commune (scald) on barley, rye and triticale; Sarocladium oryzae and S. attenuatum (sheath rot) on rice; Sclerotinia spp. (stem rot or white mold) on vegetables (S. minor and S. sclerotiorum) and field crops, such as oilseed rape, sunflowers (e.g. S. sclerotiorum) and soybeans, S. rolfsii (syn. Athelia rolfsii) on soybeans, peanut, vegetables, corn, cereals and ornamentals; Septoria spp. on various plants, e.g. S. glycines (brown spot) on soybeans, S. tritici (syn. Zymoseptoria tritici, Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setosphaeria spp. (leaf blight) on corn (e.g. S. turcicum, syn. Helminthosporium turcicum) and turf; Sphacelotheca spp. (smut) on corn, (e.g. S. reiliana, syn. Ustilago reiliana: head smut), sorghum und sugar cane; Sphaerotheca fuliginea (syn. Podosphaera xanthii: powdery mildew) on cucurbits; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria] nodorum, syn. Septoria nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e.g. T. tritici (syn. T. caries, wheat bunt) and T. controversa (dwarf bunt) on wheat; Trichoderma harzianum on mushrooms; Typhula incarnata (grey snow mold) on barley or wheat; Uro-cystis spp., e.g. U. occulta (stem smut) on rye; Uromyces spp. (rust) on vege-tables, such as beans (e.g. U. appendiculatus, syn. U. phaseoli), sugar beets (e.g. U. betae or U. beticola) and on pulses (e.g. U. vignae, U. pisi, U. viciae-fabae and U. fabae); Ustilago spp. (loose smut) on cereals (e.g. U. nuda and U. avaenae), corn (e.g. U. maydis: corn smut) and sugar cane; Ustilaginoidea virens (false smut) on rice; Venturia spp. (scab) on apples (e.g. V. inaequalis) and pears; and Verticillium spp. (wilt) on various plants, such as fruits and ornamentals, vines, soft fruits, vegetables and field crops, e.g. V. longisporum on oilseed rape, V. dahliae on strawberries, oilseed rape, potatoes and tomatoes, and V. fungicola on mushrooms; Xanthomonas oryzae (bacterial leaf blight) on rice; Zymoseptoria tritici on cereals;

In a preferred embodiment of this invention, the disease is a plant disease caused by: sheath blight (CORTSS), leaf blast (also known as rice blast; PYRIOR), panicle-neck blast (PYRPRO), bacterial leaf blight (XANTOR) & false smut (USTNVI).

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 illustrates a block diagram of an exemplary apparatus for determining a disease progression usable for fungicide spray schedule on an agricultural field.

FIG. 2 illustrates a diagram of the disease model simulating the primary infection and secondary infection.

FIGS. 3A and 3B show the distribution of observations considered for sheath blight (CORTSS), leaf blast (PYRIOR), panicle-neck blast (PYRPRO), bacterial leaf blight (XANTOR) and false smut (USTNVI), post data cleaning and processing (upper left).

FIG. 4 shows an example of disease severity interpolation using exponential growth curve.

FIG. 5 shows the distribution for number of observations considered for each disease for every country.

FIG. 6 shows the comparative analysis of observed disease severity for trial locations and the untreated locations.

FIG. 7 shows the raw predictions and smoothed raw predictions.

FIG. 8 shows a distribution of the days difference between the observed and the predicted primary infection dates for leaf blast (PYRIOR), panicle-neck blast (PYRPRO) & bacterial leaf blight (XANTOR) for all untreated locations in Japan.

FIG. 9 shows the distribution for True Positive, False Positive, True Negative and False Negative.

FIG. 10 shows the geo-spatial distribution of True Positives, False Positives, False Negatives and True Negatives for sheath blight occurrence prediction for trial locations in Japan.

FIG. 11 shows the geo-spatial distribution of True Positives, False Positives, False Negatives and True Negatives for leaf blast occurrence prediction for trial locations in Japan.

FIG. 12 shows the geo-spatial distribution of True Positives, False Positives, False Negatives and True Negatives for Panicle-Neck Blast occurrence prediction for trial locations in Japan.

FIG. 13 shows the geo-spatial distribution of True Positives, False Positives, False Negatives and True Negatives for False Smut occurrence prediction for trial locations in Japan.

FIG. 14 shows the geo-spatial distribution of True Positives, False Positives, False Negatives and True Negatives for Bacterial Leaf Blight occurrence prediction for trial locations in Japan.

FIG. 15 shows the accuracy, precision and recall.

FIG. 16 shows the feature importance for every model.

FIG. 17 shows the geo-spatial distribution for Sheath Blight disease occurrence prediction.

FIG. 18 shows the geo-spatial distribution for leaf blast disease occurrence prediction.

FIG. 19 shows the geo-spatial distribution for panicle-neck blast disease occurrence prediction.

FIG. 20 shows the geo-spatial distribution for false smut disease occurrence prediction.

FIG. 21 shows the geo-spatial distribution for bacterial leaf blight disease occurrence prediction.

FIG. 22 shows the geo-spatial distribution of maximum severity predicted by the trained models for sheath blight (CORTSS), leaf blast (PYRIOR), panicle-neck blast (PYRPRO), bacterial leaf blight (XANTOR) & false smut (USTNVI) for all locations with disease occurrence.

FIG. 23 shows the effects of disease onset date on the disease progress curve.

FIG. 24 shows the effects of variety disease resistance level on the disease progress curve.

FIG. 25 shows the effects of fungicide applications on the disease progress curve.

FIG. 26 shows a fungal disease management system.

FIG. 27 illustrates a flow chart illustrating a computer-implemented method for determining a disease progression usable for fungicide spray schedule on an agricultural field.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

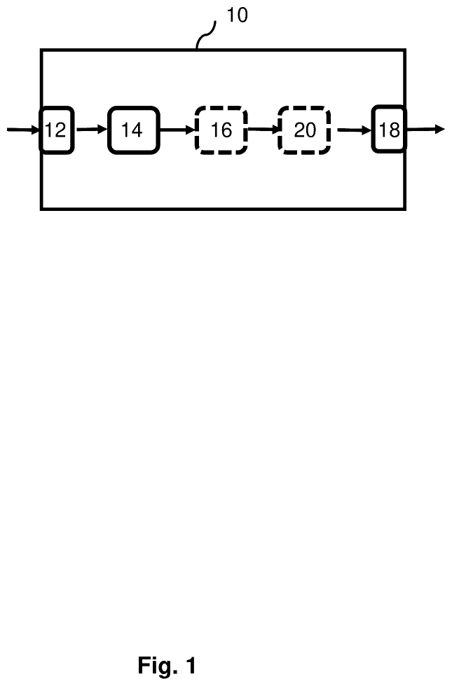

FIG. 1 shows a block diagram of an exemplary apparatus 10 for determining a disease progression usable for fungicide spray schedule on an agricultural field. The exemplary apparatus 10 comprises an input unit 12, a primary infection determination unit 14, and an output unit 18. Optionally, as shown in FIG. 1, the apparatus 10 may further comprise a secondary infection determination unit 16, and a fungicide spray schedule determination unit 20.

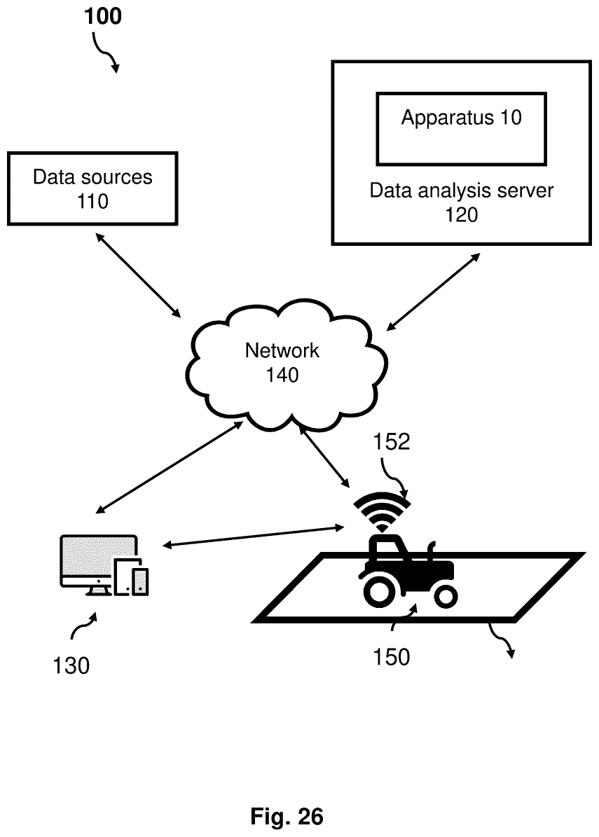

In general, the apparatus 10 may comprise various physical and/or logical components for communicating and manipulating information, which may be implemented as hardware components (e.g., computing devices, processors, logic devices), executable computer program instructions (e.g., firmware, software) to be executed by various hardware components, or any combination thereof, as desired for a given set of design parameters or performance constraints. Although FIG. 1 may show a limited number of components by way of example, it can be appreciated that a greater or a fewer number of components may be employed for a given implementation. Furthermore, the functions provided by one or more components of the apparatus 10 may be combined or separated. Moreover, the functionality of any one or more components of the apparatus 10 may be implemented by any appropriate computing environment, such as personal computing environment, time sharing computing environment, distributed computing environment, cloud computing environment, and cluster computing environment. An exemplary distributed computing environment is shown in FIG. 26.

In some implementations, the apparatus 10 may be embodied as, or in, a device or apparatus, such as a server, workstation, or mobile device. The apparatus 10 may comprise one or more microprocessors or computer processors, which execute appropriate software. The primary infection determination unit 14, the secondary infection determination unit 16, and the fungicide spray schedule determination unit 20 of the apparatus 10 may be embodied by one or more of these processors. The software may have been downloaded and/or stored in a corresponding memory, e.g., a volatile memory such as RAM or a non-volatile memory such as flash. The software may comprise instructions configuring the one or more processors to perform the functions as described herein.

It is noted that the apparatus 10 may be implemented with or without employing a processor, and also may be implemented as a combination of dedicated hardware to perform some functions and a processor (e.g., one or more programmed microprocessors and associated circuitry) to perform other functions. For example, the functional units of the apparatus 10, e.g., the input unit 12, the primary infection determination unit 14, the secondary infection determination unit 16, the fungicide spray schedule determination unit 20, and the output unit 18 may be implemented in the device or apparatus in the form of programmable logic, e.g., as a Field-Programmable Gate Array (FPGA). In general, each functional unit of the apparatus may be implemented in the form of a circuit.

In some implementations, the apparatus 10 may also be implemented in a distributed manner. For example, some or all units of the apparatus 10 may be arranged as separate modules in a distributed architecture and connected in a suitable communication network, such as a 3rd Generation Partnership Project (3GPP) network, a Long Term Evolution (LTE) network, Internet, LAN (Local Area Network), Wireless LAN (Local Area Network), WAN (Wide Area Network), and the like.

In this following, we describe a hybrid model to simulate the epidemics of crop diseases and impact of weather, variety and fungicide on disease progress by way of an example. The model can be used to optimize fungicide application timing. In the hybrid model, a machine-learning based (ML) model is trained to simulate the primary infection—i.e., the onset of the disease. A process-based model is developed to simulate the secondary infections with processes included susceptible, exposed, infectious, and removal. Environmental factor including temperature and wetness are considered for infection rate. The variety susceptibility, fungicide and crop growth stage are also considered in the infection rate calculation. We found that the ML model can simulate the disease onset day within 5d accuracy for 75% of the locations. ML model can simulate the disease occurrence 85% accuracy. The process-based model may also be used to simulate the interactions between disease onset date, variety susceptibility and fungicide application.

### 1. The Overall Model Architecture

Polycyclic disease progress can be described by the logistic equation:

$$\frac{dy}{dx} = ry ( 1 - y ) \qquad ( Eq . 1 )$$

where y is the disease severity (which ranges from 0 to 1) and r is the rate parameter (infection rate).

Integration of the logistic equation results in the following term:

$$y = \frac{1}{1 + [ ( 1 - {y}_{0} ) / {y}_{0} ] {e}^{- rt}} \qquad ( Eq . 2 )$$

In Eq. 2, y₀ describes the disease level at the onset of disease and is closely related to the life cycle of the pathogen.

Many pathogens (e.g., leaf blast) generate spores associated with sexual and asexual reproduction. Sexual spores often bridge adverse and/or non-host periods and are responsible for the first infections (primary infections) of the season. Asexual spores produced on primary lesions generate repeating (secondary) infections during the crop's growing season. These two kinds of spores often have different environmental condition requirements and different epidemiological characteristics. The occurrence and progress of epidemics caused by these fungi are due to the concatenation and co-occurrence of the two types of infection cycles (primary and secondary cycles) for a certain period during the growing season of the host plant.

The progress of these epidemics can be written as follows:

$${y}_{t} = {\sum }_{t = {t}_{0}}^{{t}_{p}} {y}_{0 t}^{′} + {\sum }_{t = {t}_{0 + p}}^{{t}_{e}} {y}_{t}^{′} \qquad ( Eq . 3 )$$

where y′₀=daily increase of disease intensity due to the primary inoculum, t₀=time of first seasonal disease onset, tₚ=time when there is no more primary inoculum, p=latent period for the first infection cycle, y′ₜ=daily increase of disease intensity due to secondary inoculum, and tₑ=time when the epidemic ends.

Other pathogens like Rhizoctonia solani for sheath blight primary spores usually originate from surviving forms, like stromata, sclerotia, or mycelia. The progress of epidemics caused by these pathogens can be written as follows:

$${y}_{c} = {y}_{0} + {\sum }_{t = {t}_{0 + p}}^{{t}_{e}} {y}_{t}^{′} \qquad ( Eq . 4 )$$

Due to the complexity and uncertainty of the primary inoculum of airborne disease like leaf blast, there is still no reliable mechanism model to simulate the disease onset and initial severity.

Towards this end, an apparatus and a computer-implemented method are provided that use a trained machine-learning model to simulate the disease onset date or there is no infection for the entire season. Optionally, after the onset date is predicted, the apparatus and the computer-implemented method may use it as a starting point and use a mechanism model to simulate the secondary infection and disease cycle.

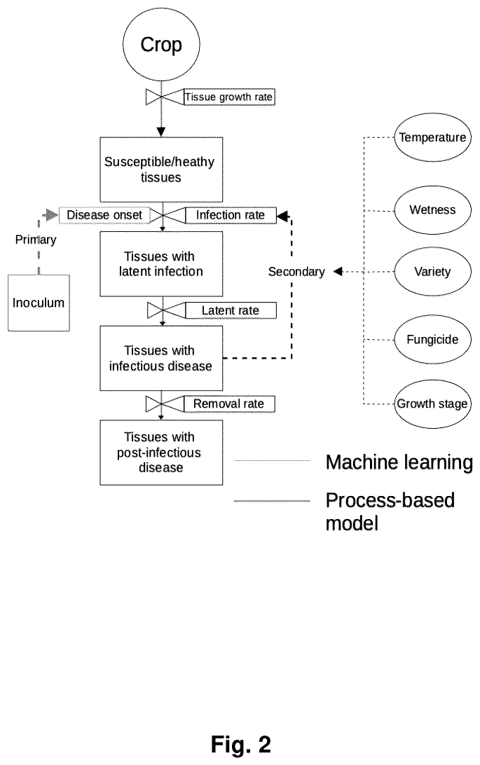

For example, FIG. 2 shows a diagram of the disease model simulating the primary infection and secondary infection. State variables (shown as rectangular boxes) are linked by rate variables. The primary infection is simulated by the machine-learning based model, e.g., via the primary infection determination unit 14 of the apparatus 10 shown in FIG. 1. The secondary infection may be simulated by process-based model e.g., by the secondary infection determination unit 16 of the apparatus 10 shown in FIG. 1.

### 2. Methods

2.1 Trial Data and Newly Collected Data from Public Source

The data may be sourced from public sources. For example, these fields captured in the public data were geographically or historically high-risk fields in Japan. The fields had high disease pressure for almost every year.

The public data for untreated locations in Japan consisted of information about the transplanting date of the crop, the crop establishment growth stage, the evaluation or the observation, the evaluated disease, the observed parameter (such as growth stage, infestation percentage, first symptom observed date, the no of disease spot, etc.), the latitude and longitude, the evaluated number of hills and the evaluation score i.e. the growth stage value or the disease infestation. The data also contained other metadata such as field name, field address, the province, the replication number and the variety of crop.

There were in total 96 locations, for which the disease data was captured. The historical disease data collected, had date ranges from 2004 till 2019. The data was available for all rice diseases i.e. false smut, sheath blight, leaf blast, panicle blast and bacterial leaf blight except for brown spot. The data consisted of 21 columns and 4304 rows. Of the 4304 rows of observation made, 243 were about GS observations.

### 2.2 Historical Untreated Data Preparation

The public dataset for untreated plots needed cleaning and transformation to be used to retrain and re-evaluate the model performance for predicting disease severity. For data cleaning, we removed rows from the data which had incorrect date values for ‘Evaluated date’. The values contained values such as ‘early July’. We also cleaned the ‘Evaluated date’ column by converting the Chinese values into their numerical equivalent. The values cleaned were the numerical equivalents for ‘middle ten-day period of a month’, ‘first ten-day period of a month’, and ‘last ten-day period of a month’. We removed rows which did not have a transplanting date. Next, we also removed rows which had incorrect evaluation date for the transplantation year. We compared the evaluation year with the transplantation year and removed rows for which the values didn't match. We had 76 instances of mismatch between evaluation year and transplantation year. Later we corrected rows where evaluation score contained non-numeric values such as ‘1 leaf stage’.

Once the data was cleaned, we converted all the disease information into disease severity. As there were many target values for each disease type, we considered the multiple values for ‘Evaluation Item’ in different diseases. For PYRIOR (leaf blast) we used “severity (total hill)”, if that value was missing, we took “No. of disease spot”. For PYRPRO (panicle-neck blast), we considered “severity (total hill)”. For USTNVI (false smut) we used “No. of infested grain”, if that was missing, we considered “No. of infested panicle”. For CORTSS (sheath blight) we considered “severity (total hill)” and for XANTOR (bacterial leaf blight) we considered “severity (total hill)”. We use either of the values for ‘Evaluation Item’ column as some locations have only one of the value for Evaluation Item.

For data transformation, we aggregated the disease data for every location (i.e. latitude and longitude), for every season against all the replications. After this aggregation we end up with 450 rows of disease severity for 85 unique locations.

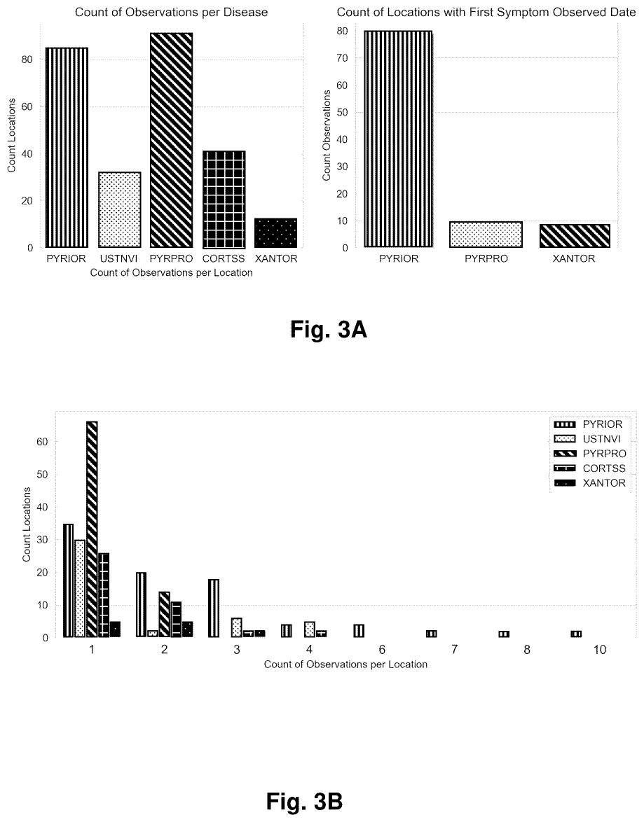

The distribution of assessment counts across all the 450 assessments, for every disease can be seen in FIG. 3A (left figure). The count of observations for leaf blast is higher than for the rest of the diseases.

FIGS. 3A and 3B show the distribution of observations considered for sheath blight (CORTSS), leaf blast (PYRIOR), panicle-neck blast (PYRPRO), bacterial leaf blight (XANTOR) and false smut (USTNVI), post data cleaning and processing (upper left). The distribution of count of locations with first symptom observed date or disease start date for cleaned and transformed untreated disease data for Japan (see left figure of FIG. 3A). The distribution of count of locations for total count of observations per location (see FIG. 3B). For example, the count of locations with at least three observation for bacterial leaf blight for all seasons combined is just 3. Similarly, the count of locations with a total of 6 observations for leaf blast is 2.

Our final goal with data pre-processing, was to convert the discrete disease assessment into continuous disease severity values for each day. For this we needed the start disease date of a disease along with the starting severity. After evaluating the start disease date information, we would fit an exponential growth curve from the starting day of disease till the last evaluation day. Unfortunately, we did not have the start disease date for all locations. This adds complexity to the process of converting the discrete disease severity to the daily continuous form. Error! Reference source not found. (bottom) shows the number of locations with their overall location count for every disease. For example, from the plot we can notice that the count of locations with at least three observation for bacterial leaf blight for all seasons combined is just 1. Similarly, for minimum 4 observations, we have just 2 locations for leaf blast.

The disparity in the locations which have first symptom observed date or the disease start date is represented in FIG. 3A (right). We have 79 locations for leaf blast, 9 for panicle blast and 8 locations for bacterial leaf blast. For 2020 trials data, we ideally used 5-10 observation of the disease done with a maximum gap of 14 days. Currently, we only considered those locations which have a start disease date and we end up with just 57 observations from a total of cleaned and transformed 278 observations. We fit use the ‘Exponential Growth Function’ for those observed disease severities.

We devised an algorithm to convert the discrete disease severity to its continuous form. First, we take all disease assessment points along with their index starting from the start disease date. Next, normalize the disease severity values to keep an upward trend in the disease data. Example, if we have a disease values as [1, 19, 25, 6, 32] for six observations, we change the values to [1, 19, 25, 25, 32]. The plateauing the downward curve retains the exponential growth's characteristics. We then fit the disease severity values onto the equation below:

$$y = a * {e}^{- b * x} + c \qquad ( Eq . 5 )$$

By applying the above algorithm, we were able to convert discrete disease severity into daily continuous disease curve.

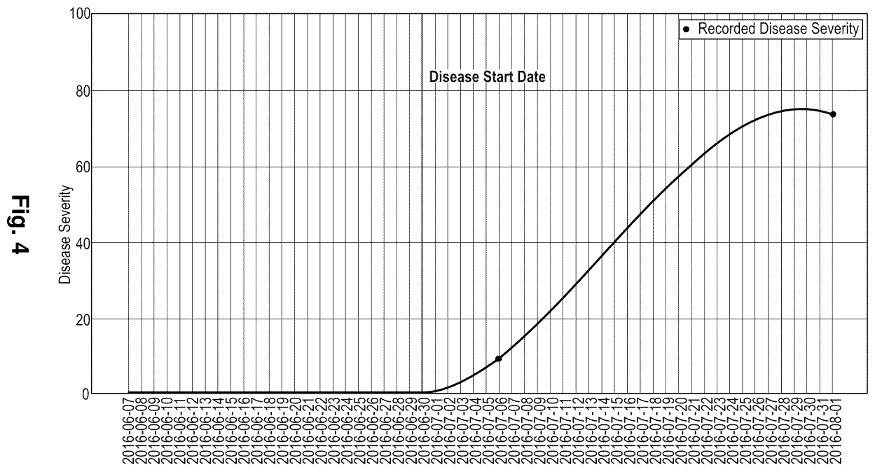

FIG. 4 shows an example of disease severity interpolation using exponential growth curve. The black dots represent the observed disease severity, the vertical line represents the observed disease start date and the curve is interpolated based on the algorithm.

### 3. Primary Infection Determination Unit

The input unit 12 is configured to receive data including crop variety data, environmental data, crop management data, and location data of the agricultural field.

The crop variety data relates to a crop grown or to be grown on an agricultural field. Exemplary crop variety data may include, but is not limited to, growth stage at a specific time point, crop density (i.e. number of crops present per unit area of the field), and days after plantation. The crop variety data may be obtained from the field data of the agricultural field.

The environmental data is indicative of an environmental condition for the agricultural field. Exemplary environmental data may include, but is not limited to, air temperature, cloud cover, dew point, short wave radiation, long wave radiation, ice accumulation period, liquid accumulation period, relative humidity, precipitation accumulation period adjusted, snow accumulation period, wind speed. In some examples, the environmental data may be collected by sensors deployed on the agricultural field. In some examples, the environmental data may be received from a weather forecasting service.

The crop management data indicative of fungicide spray history for the agricultural field. The crop management data may be obtained from a data management system that stores the fungicide spray history for the agricultural field.

The location data of the agricultural field may include latitude and longitude data (e.g., decimal degrees, negative values for south or west) of the agricultural field, which may be obtained from the field data of the agricultural field.

The primary infection determination unit 14 is configured to applying a machine-learning model to the received data to determine disease progression time-series data of a fungal disease. The machine-learning model has been trained to learn the disease progression under a condition defined by crop variety data, environmental data, and location data based on historic data collected from one or more agricultural fields.

The machine-learning model may be any appropriate model capable of determining disease progression time series data of a fungal disease. Examples of the machine-learning model may include, but are not limited to, XGBoost, Artificial Neural Network, Recurrent Neural Network and Support Vector Regression.

The primary infection determination unit 14 may be further configured to determine, based on the determined disease progression time-series data, a disease onset date of the fungal disease. For example, the disease onset date of the fungal disease may be determined utilizing a change point detection algorithm.

The machine-learning modelling will be explained in detail hereinafter.

### 3.1 Feature Engineering

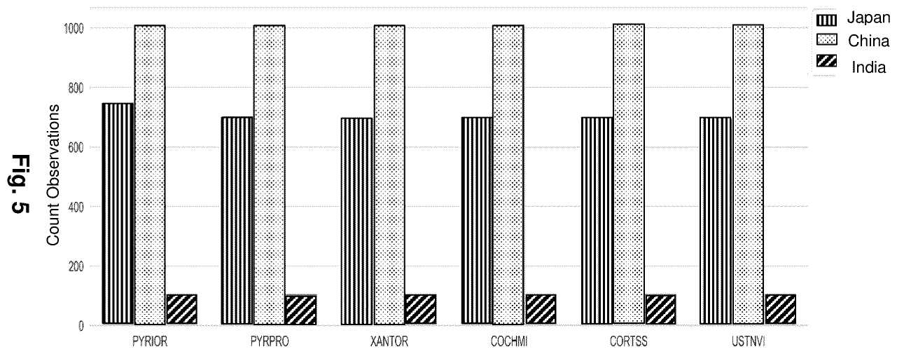

The historical interpolated untreated disease data from Japan was concatenated with the Xarvio trials data for India, Japan and China. FIG. 5 represents the distribution for number of observations considered for each disease for every country. We can notice a uniformity in the distribution of number of observations for every disease for every country. This is the result of recording a severity of zero for all diseases if the infestation is not observed for a given observation date.

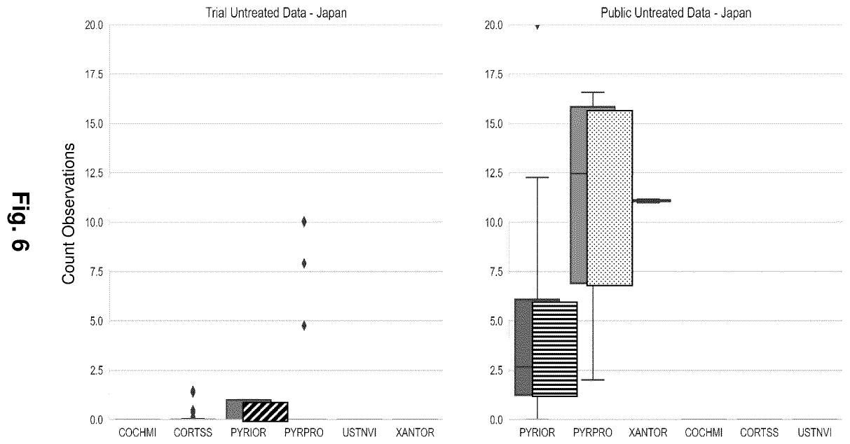

FIG. 6 captures the comparative analysis of observed disease severity for trial locations and the untreated locations. We observe a higher distribution of disease severity for all diseases in the historical untreated fields public data compared to the disease severity in trial locations. The public untreated data had disease severity for all disease, however the captured distribution. FIG. 6 (right) is only for leaf blast, panicle-neck blast and bacterial leaf blight. These diseases are only considered for modelling as their observations had a disease start date.

The data for every disease was pre-processed and feature engineered. The numeric data was not scaled as we had planned to use a non-linear tree-based algorithm for training the machine-learning model. A tree-based model is scale insensitive. The features used for training, testing and validating the model can be divided into three sub types and they are represented in Table 1. The growth stage data was simulated from the Growth Stage model developed in Growth stage simulation model for rice. The weather data was collected from ITERIS (ClearAG, n.d.) for every location. The target for the model was the disease severity/infestation percentage.

TABLE 1

| Feature Category | Features |
|---|---|
| Plant | Growth stage, days after plantation. |
| Weather | Air temp, cloud cover, dew point, short wave |
| | radiation, long wave radiation, ice |
| | accumulation period, liquid accumulation |
| | period, relative humidity, precipitation |
| | accumulation period adjusted, snow |
| | accumulation period, wind speed. |
| Location | Latitude, longitude. |

The latitude and the longitude data were divided by 10 and the ceiling value was considered for modelling. This disabled the possibility of the model becoming overly sensitive or biased to these two features. Of the 500 locations in the dataset, we segregated 40 fields for validation of every model. The rest 460 field's data were broken split as 80% train and 20% test.

### 3.2 Machine-Learning Model Training

We trained an individual model for every disease instead one model for all diseases combined. This enabled every individual model to have a deeper understanding of the abstract relationships between the features.

Any appropriate machine-learning model capable of determining disease progression time series data of a fungal disease may be employed. Examples of the machine-learning model may include, but are not limited to, Xtreme Gradient Boosting (XGB) regression model, Artificial Neural Network, and Support Vector Regression. An exemplary machine-learning model, XGB regression model, will be described in detail hereinafter.

The model of choice was an XGB regression model tuned over a Randomized Search Cross validation. XGB is a scalable tree boosting system and can be thought of as gradient boosting with regularization. It enables parallelized tree building, cache-aware access, sparsity awareness, and weighted quantile sketch as some of its systems optimization and algorithmic enhancements.

The hyper-parameter range passed for tuning of XGB is explained in Table 2. The most important hyper parameters were the maximum depth and the number of estimators. Tuning the hyper-parameters, gives the model the ability to search the best fit. Each hyper parameter affects the model in certain way. Adjusting the learning rate, we prevent overfitting. Additionally, the lower the learning rate, the more robust the model will be in preventing overfitting. Maximum depth refers to the depth of a tree or estimator within the XGB model. It sets the maximum number of nodes that can exist between the root and the farthest leaf. The lower the maximum depth, lesser is the extent of overfitting. The minimum child weight performs regularization at the splitting step. It is the minimum Hessian weight required to create a new node. The Hessian is the second derivative of XGB model equation. Maximum delta step sets the maximum absolute value possible for the weights. It is useful when dealing with unbalanced classes or data. Number of estimators represent the total number of trees built for the overall XGB model. Generally, smaller number of estimators lead to a better over-all fit. However, it might not hold true for data with higher bias.

TABLE 2

| Parameter Name | Grid Values |
|---|---|
| Learning rate | [0.01, 0.05, 0.1, 0.3] |
| Maximum depth | [2, 3, 4, 5, 6, 7, 8, 10, 12, 18] |
| Minimum child weight | [1, 2, 5, 10, 15, 20] |
| Maximum delta step | [0, 1, 2, 5, 10, 15, 20] |
| Number of estimators | [100, 200, 300, 400, 500, 600, 700, 800, |
| | 900, 1000, 1100, 1200] |

### 3.3 Change Detection for the Disease Onset

To calculate the disease starting date, we clean the raw disease time curve predicted by the model and run a change point detection algorithm to start point index of a curve.

For cleaning the disease curve post prediction, we first stabilize noise from the model by converting any prediction below 0.3 as 0. We then decompose the curve using seasonal decompose process. The results are obtained by first estimating the trend by applying a convolution filter to the data. The trend is then saturated from the curve and passed along. This reduces the gaussian noise from the raw predictions. The decomposed curve is smoothened using Convolution based smoothening using a Python wrapper, tsmoothie. The smoothened curve is then passed onto a slope-based start point detection algorithm. In the algorithm, we apply a 7-day rolling slope. The first point on the rolling slope curve with value more than or equal to 0.1 is selected as the start. The below figure represents the disease start point detection is action.

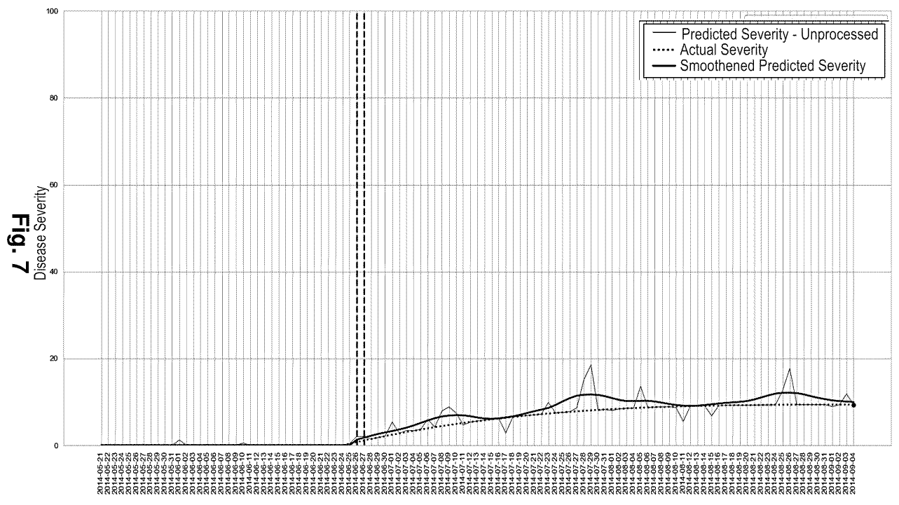

FIG. 7 shows the raw predictions, which are smoothened and cleaned as the curve. The black dotted curve is the actual severity. The vertical dotted lines are the generated disease start dates. The dotted vertical line is for the predicted disease start date and the black dotted vertical line is for the onset of the observed disease severity.

### 3.4 Machine-Learning Model Validation

Based on the observed disease severity for the Xarvio trial locations in 2020, we calculated and ascertained locations for a given crop season where correct and the incorrect predictions were made. The disease or no disease scenario was calculated based on the presence of a disease start point. The disease curve where an absence of disease start point was observed was tagged as no disease location and vice versa. The crop seasons were marked as True Positives i.e. a location where disease was observed and the model also predicted a disease, False Positives i.e. a location where a disease was not observed but the model predicted a disease, False Negatives i.e. a location where disease occurred but the model didn't predict a disease and True Negatives i.e. a location where no disease was observed and the model also didn't predict any disease.

Post training of machine-learning models, we utilized the untreated fields data from Japan to ascertain the model effectiveness. Apart from considering the Mean Absolute Error (MAE) and Root Mean Squared Error (RMSE) on test data for model validation, we consider the days difference between the start disease date in the disease curve predicted by the model and the start disease date in the observed disease severity curve for every location for every season and for each disease. We generated the days difference between the start disease date in the disease curve predicted by the model and the start disease date in the observed disease severity curve for every location for every season and for each disease, we begin with predictions, then cleaning and smoothening of the predicted disease curve and finally generating the change points i.e. the disease start point/date. Later, we compare the results for all the untreated fields. Of the 74 disease severity time series for untreated fields, 20 fields were from validation data (i.e. they were not used for training of the model) and rest 54 disease severity time series were used in training.

Based on the prediction data for trial locations and the untreated locations, we calculated the overall accuracy, precision and recall for all disease from the formulae in the following equations.

$$Accuracy = \frac{( True Positives + True Negatives )}{\begin{matrix}( True Positives + False Negatives + \\ True Negatives + False Positives )\end{matrix}} \qquad ( Eq . 6 )$$

$$Precision = \frac{True Positives}{( True Positives + False Positive )} \qquad ( Eq . 7 )$$

$$Recall = \frac{True Positives}{( True Positives + False Positives )} \qquad ( Eq . 8 )$$

We also ran simulations for all rice growing regions in Japan for the year 2019. There were a total of 2721 locations around Japan. We made predictions for disease severity for all the locations, we later cleaned each predicted disease severity curve and smoothened it to pass is to the disease start point detection algorithm to detect the start point of the disease. Once we predicted the disease start date, we calculated the growth stage and the days after planting on the disease onset day.

### 4. Secondary Infection Determination Unit

The optional secondary infection determination unit 16 is configured to apply a process-based model to determine an infection rate of the fungal disease after the disease onset day under a condition defined by the crop variety data, environmental data, crop management data, and the location data.

In some examples, the infection rate of the fungal disease may be determined by further including a condition defined by a variety disease resistance level of the crop.

In some examples, the infection rate of the fungal disease is determined by further including a condition defined by fungicide application data including fungicide data of a fungicide product to be used and at least one planned application timing.

The process-based disease model will be explained in detail hereinafter.

### 4.1 Structure of the Process-Based Disease Model

The process-based disease model may include any suitable model can project how infectious diseases progress to show the likely outcome of an epidemic in plants and help inform plant health interventions. An example of the process-based disease model is a compartmental model that is formulated as Markov chains. A classic compartmental model in epidemiology is the SIR model, which may be used as a simple model for modeling epidemics. Multiple other types of compartmental models are also employed. An exemplary process-based disease model, SEIR model, will be explained in detail hereinafter. However, it can be appreciated that any model capable of modelling epidemics of infectious diseases of plants may be implemented as the process-based disease model.

The structure is a SEIR model (susceptible-exposed-infectious-removed), which has been widely used to model epidemics of infectious diseases of plants. The process-based model structure is based on the concept of the reference: Van der Plank, J. E., 2013. Plant diseases: epidemics and control. Elsevier., using the systems representation of the reference: González-Dominguez, E., Fedele, G., Salinari, F., Rossi, V., 2020. A General Model for the Effect of Crop Management on Plant Disease Epidemics at Different Scales of Complexity. Agronomy 10, translated to botanical epidemiology by the reference: Zadoks, J., 1971. Systems analysis and the dynamics of epidemics. Phytopathology 61, 600-610.

The system considered is 1 m² of a rice crop stand, and epidemics are simulated over the crop duration according to the growth stage model results. It involves four state variables of a crop stand: healthy (H), latent (L), infectious (I), and post-infectious sites (P).

A central element of the model is the rate of daily infection yₜ′, which is written as:

$${y}_{t}^{′} = {RC}_{i} * INF * {COFR}^{Agg} \qquad ( Eq . 9 )$$

where, yₜ′ is the daily infection rate, RCᵢ is the favorability of environment, INF is the number of infectious site, COFR is a correction factor for disease sites.

$${RC}_{i} = RCOpt * RCGS * RCT * RCW * RCV \qquad ( Eq . 10 )$$

where RCOpt is the infection rate under favorable condition, RCGS is the modifier for crop growth stage, RCT is the modifier for temperature, RCW is the modifier for leaf wetness, RCV is the modifier for variety resistance.

$${TTA}_{i} = \sum {RTG}_{i} = \sum RRG * {HTA}_{i} * ( 1 - ( \frac{{TTA}_{i}}{{TA}_{max}} ) ) \qquad ( Eq . 11 )$$

where RRG is the relative rate of tissue growth, HTAᵢ is the heathy tissues at day i, TAₘₐₓ is the maximum tissue area.

$${HTA}_{i} = \sum {RTG}_{i} - {DST}_{i} - {Sene}_{i} \qquad ( Eq . 12 )$$

where DSTᵢ is the disease tissue at day i, Seneᵢ is the senescence at day i.

### 5. Results

### 5.1 Primary Infection Determination Unit

### 5.1.1 Machine-Learning in Predicting the Disease Onset Date

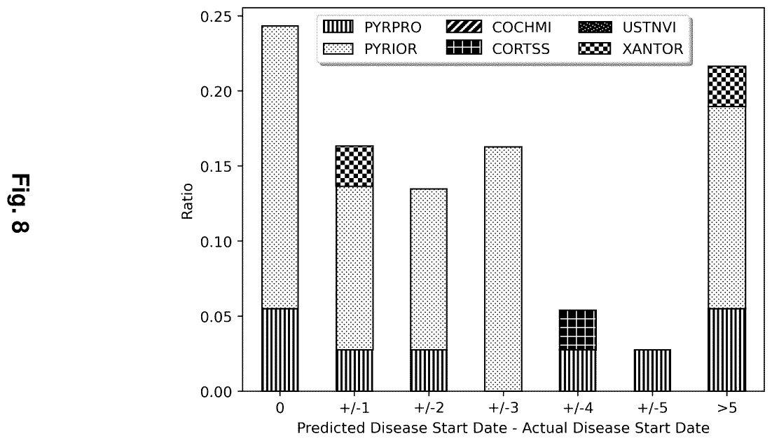

A distribution of the days difference between the predicted start date and the observed start date for all 74 disease severity time series is represented in FIG. 8, including the distribution of the days difference between the observed and the predicted primary infection dates for leaf blast (PYRIOR), panicle-neck blast (PYRPRO) & bacterial leaf blight (XANTOR) for all untreated locations in Japan.

### 5.1.2 the Model Accuracy in Simulating Disease Occurrence

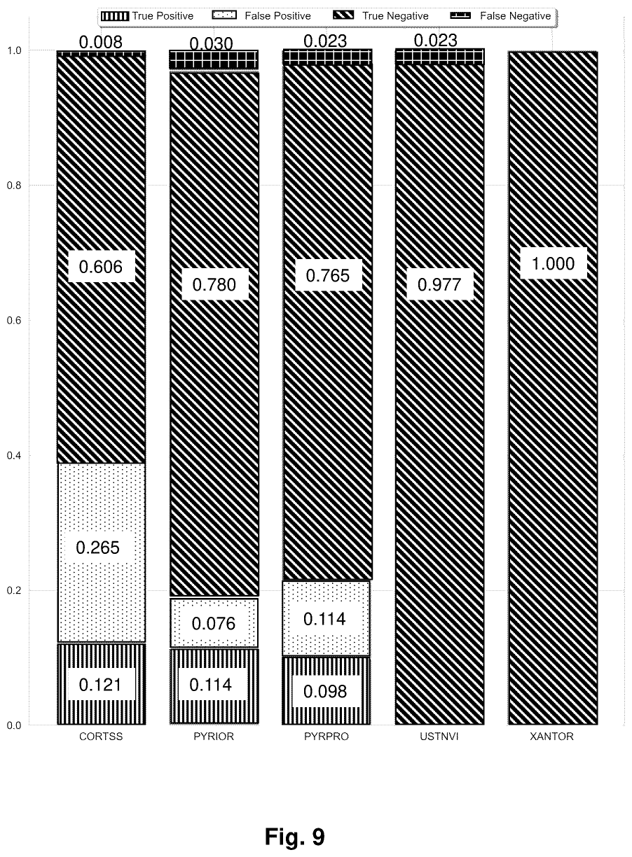

The distribution for True Positive, False Positive, True Negative and False Negative is represented in FIG. 9, which shows the distribution of True Positives, False Positives, True Negatives and False Negatives for sheath blight (CORTSS), leaf blast (PYRIOR), panicle-neck blast (PYRPRO), bacterial leaf blight (XANTOR) & false smut (USTNVI) for all trial locations in Japan.

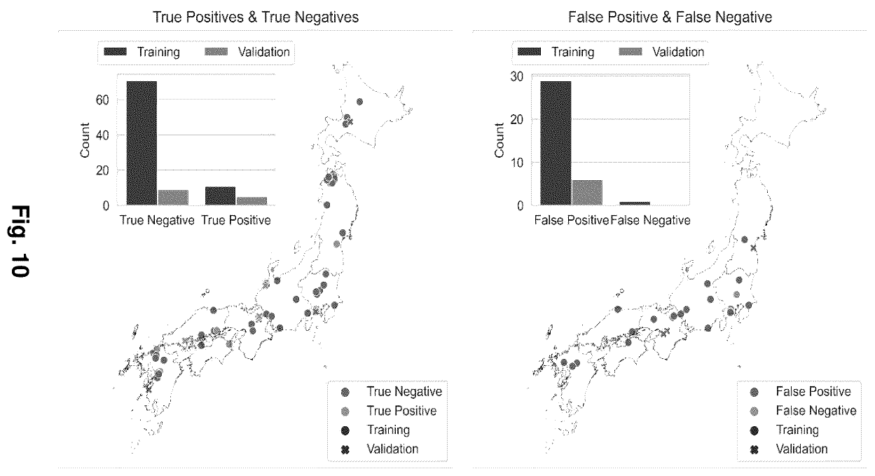

The geo-spatial representation for True Positive, False Positive, True Negative and False Negative for every disease can be seen in FIGS. 10 to 14. The left side of the figure confirm the places where we made the correct prediction by providing the geo-spatial locations with tags of True Positive & True Negative and the right plot suggests the places where an incorrect prediction was made i.e. where we predicted a False Positive & a False Negative.

In particular, FIG. 10 shows the geo-spatial distribution of True Positives, False Positives, False Negatives and True Negatives for sheath blight occurrence prediction for trial locations in Japan. The crosses represent the locations used for validation while the circles represent locations that were used during training.

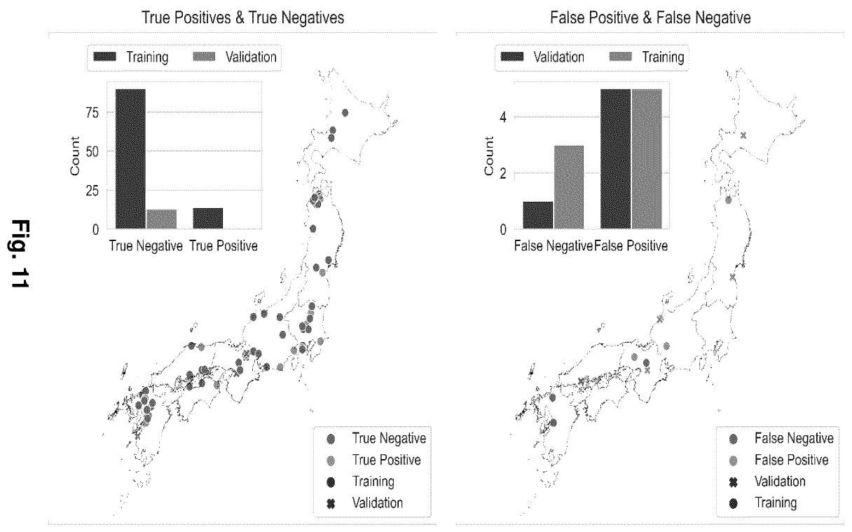

FIG. 11 shows the geo-spatial distribution of True Positives, False Positives, False Negatives and True Negatives for leaf blast occurrence prediction for trial locations in Japan. The crosses represent the locations used for validation while the circles represent locations that were used during training.

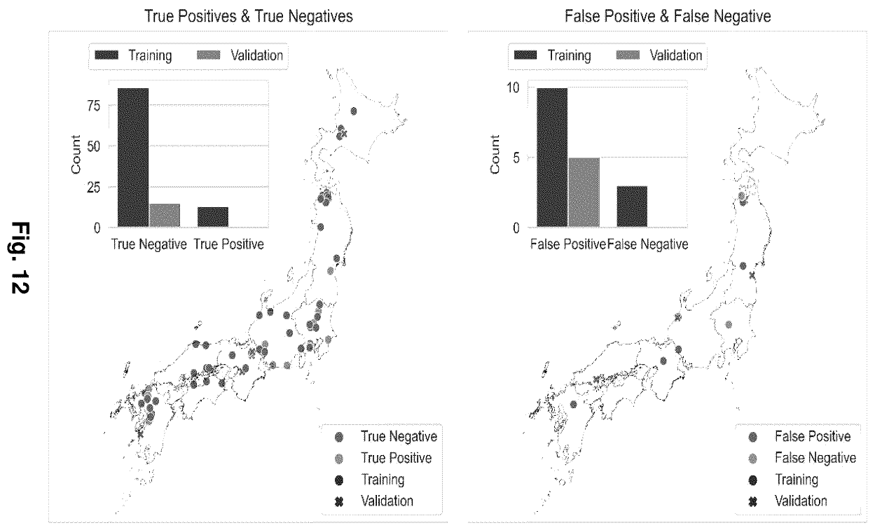

FIG. 12 shows the geo-spatial distribution of True Positives, False Positives, False Negatives and True Negatives for Panicle-Neck Blast occurrence prediction for trial locations in Japan. The crosses represent the locations used for validation while the circles represent locations that were used during training.

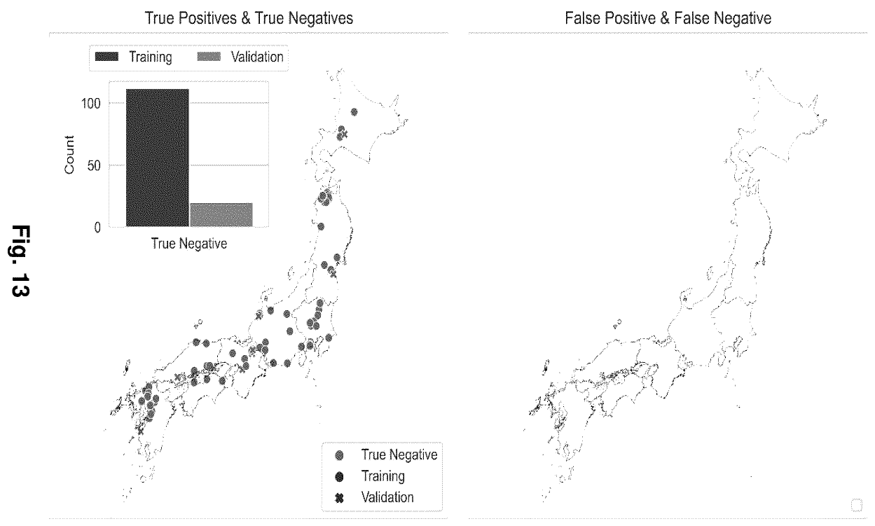

FIG. 13 shows the geo-spatial distribution of True Positives, False Positives, False Negatives and True Negatives for False Smut occurrence prediction for trial locations in Japan. The crosses represent the locations used for validation while the circles represent locations that were used during training.

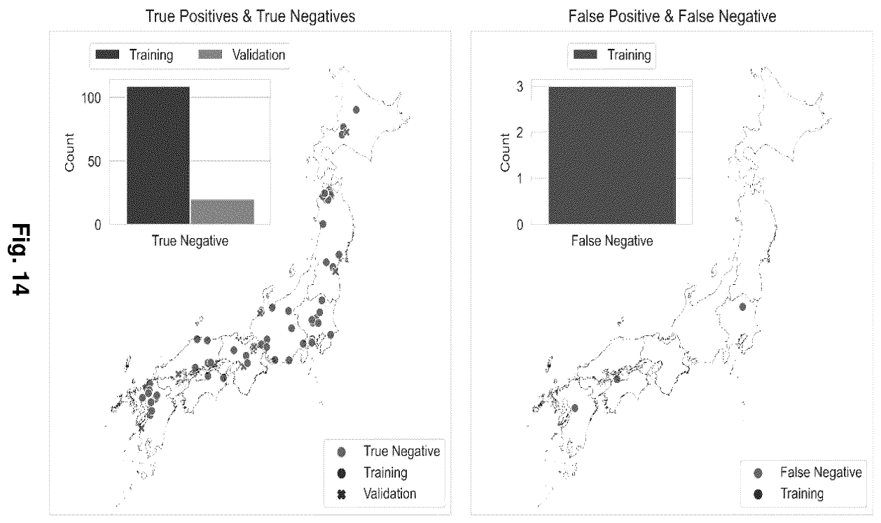

FIG. 14 shows the geo-spatial distribution of True Positives, False Positives, False Negatives and True Negatives for Bacterial Leaf Blight occurrence prediction for trial locations in Japan. The crosses represent the locations used for validation while the circles represent locations that were used during training.

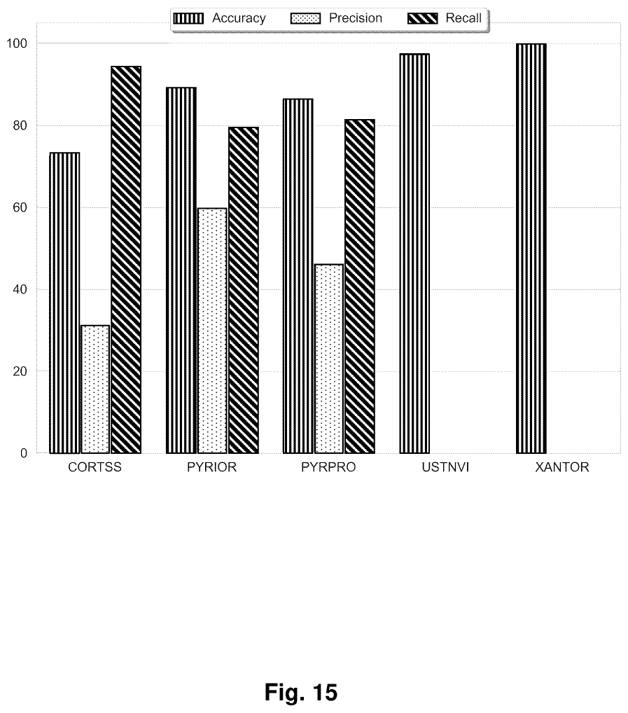

The accuracy, precision and recall are represented in FIG. 15, which represents the accuracy, precision and recall for sheath blight (CORTSS), leaf blast (PYRIOR), panicle-neck blast (PYRPRO), bacterial leaf blight (XANTOR) & false smut (USTNVI) for all locations for Xarvio Trials in Japan. The disease or a no disease scenario was calculated based on the disease start point in the predicted disease curve for each location. The values were calculated for all trial locations in Japan. A total of 140 locations were considered for calculating the performance of which 80 were used for training, 20 for testing the model and 40 were used for validation.

### 5.1.3 Importance of Features

We calculated the importance of each feature used to train each model. The features utilized to train the model is tabulated in Table 1. Two plant related features, twelve weather related features and two location related features were used to train each model.

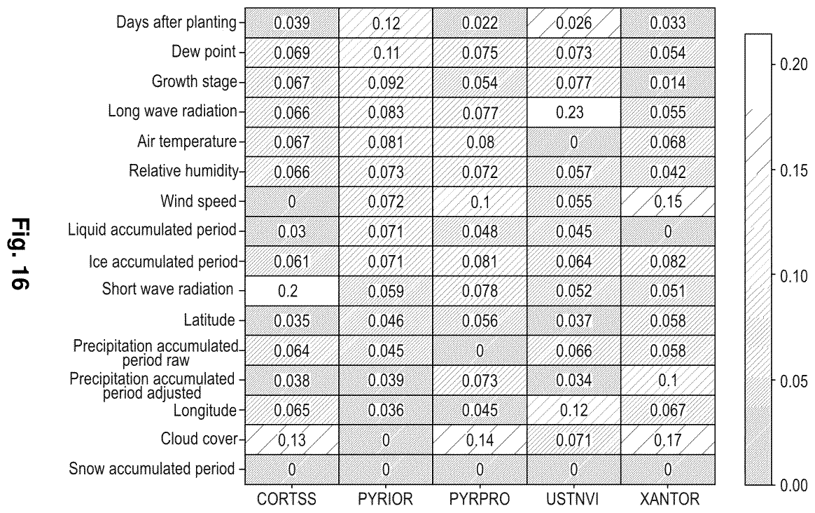

The feature importance for every model is represented in the heatmap in FIG. 16, which shows the feature importance for the trained machine-learning models for sheath blight (CORTSS), leaf blast (PYRIOR), panicle-neck blast (PYRPRO), bacterial leaf blight (XANTOR) & false smut (USTNVI). Every column indicates the trained model for a disease and the rows represent every feature used for training the model. The number in each cell represent the ratio of importance of the feature in the model. The colors are also indicative of the relative importance. The number in each cell are indicative of the ratio of importance they have over the model.

Every XGB model gives importance to days after planting, the location indicator, the growth stage and the weather-related features in a different order. The number in each cell represent the ratio of importance of the feature in the model. The colors are also indicative of the relative importance. The features that may be relatively important for model trained for sheath blight are short wave radiation and cloud cover. For leaf blast, the days after plantation and dew point seem to have significant predictive power on disease severity. For panicle blast, wind speed and cloud cover are the most important features. The model for false smut however gives more importance to short wave radiation and longitude. This phenomenon of giving higher importance to the location indicator i.e. longitude is a result of the disease severity used to train the model. As fields in Japan are treated appropriately with fungicide, the overall disease infestation or disease severity observed is less than the fields in China and India. The model compensates for such a distribution of disease severity by giving more preference to the location indicator. As there was a chance of the model getting more sensitive to the location information i.e. latitude and longitude, we reduced the bias by dividing the latitude and longitude value by 10 and taking the ceiling value. For example, if the latitude value is 79.884, we converted the value to 8 instead of considering the actual float value. This reduced the extent of sensitivity the model might allocation to the location information. For bacterial leaf blast, the most important features are the cloud cover, wind speed and precipitation accumulated period adjusted. The important weather features such as dew point, air temperature and the wind speed which relate to the overall leaf wetness.

### 5.1.4 Simulation Results for all Growing Areas

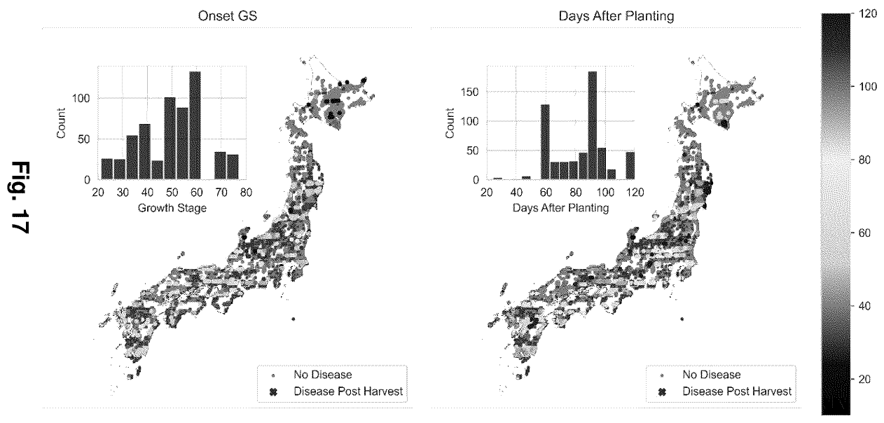

The onset GS or the growth on the day of disease start and the onset days after planting are geo-spatially represented in FIGS. 17-21.

FIG. 17 shows the geo-spatial distribution for Sheath Blight disease occurrence prediction. The left panel of the figure represent the mapping for onset GS i.e. the growth stage recorded on the day of disease start, the left panel of the plot represents the onset days after planting i.e. the day difference between crop establishment date and disease start date. The intensity of the onset GS value and the onset days after planting were captured by a color map. The inset histogram represents the distribution of each of the variables considered. The locations in gray represent no disease scenario, the locations with forest green crosses represent locations where a disease was predicted post-harvest.

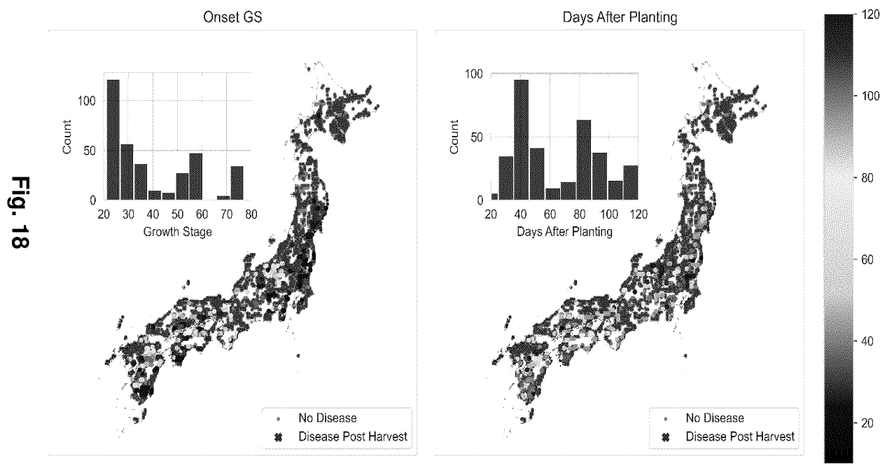

FIG. 18 shows the geo-spatial distribution for leaf blast disease occurrence prediction. The left panel of the figure represent the mapping for onset GS i.e. the growth stage recorded on the day of disease start, the left panel of the plot represents the onset days after planting i.e. the day difference between crop establishment date and disease start date. The intensity of the onset GS value and the onset days after planting were captured by a color map. The inset histogram represents the distribution of each of the variables considered. The locations in gray represent no disease scenario, the locations with forest green crosses represent locations where a disease was predicted post-harvest.

FIG. 29 shows the geo-spatial distribution for panicle-neck blast disease occurrence prediction. The left panel of the figure represent the mapping for onset GS i.e. the growth stage recorded on the day of disease start, the left panel of the plot represents the onset days after planting i.e. the day difference between crop establishment date and disease start date. The intensity of the onset GS value and the onset days after planting were captured by a color map. The inset histogram represents the distribution of each of the variables considered. The locations in gray represent no disease scenario, the locations with forest green crosses represent locations where a disease was predicted post-harvest.

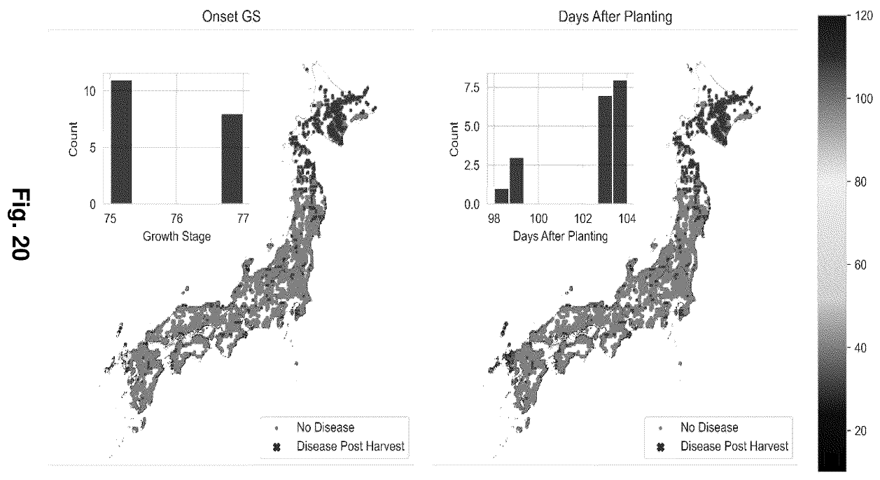

FIG. 20 shows the geo-spatial distribution for false smut disease occurrence prediction. The left panel of the figure represent the mapping for onset GS i.e. the growth stage recorded on the day of disease start, the left panel of the plot represents the onset days after planting i.e. the day difference between crop establishment date and disease start date. The intensity of the onset GS value and the onset days after planting were captured by a color map. The inset histogram represents the distribution of each of the variables considered. The locations in gray represent no disease scenario, the locations with forest green crosses represent locations where a disease was predicted post-harvest.

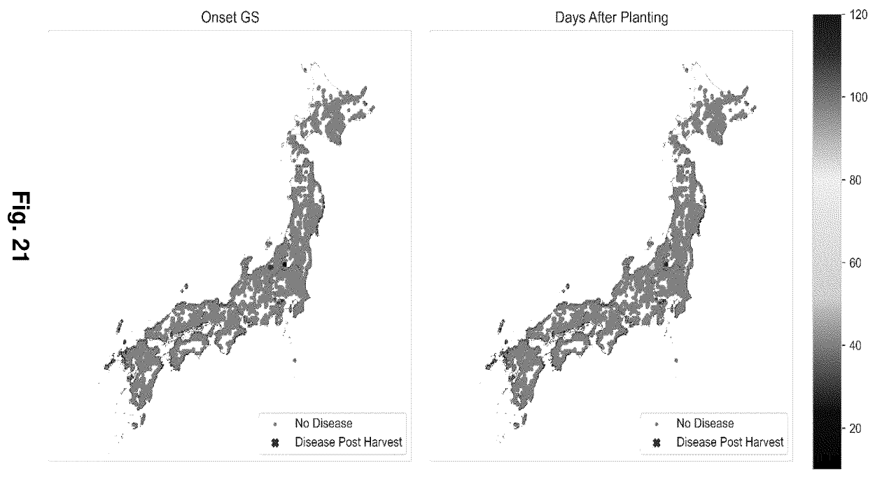

FIG. 21 shows the geo-spatial distribution for bacterial leaf blight disease occurrence prediction. The left panel of the figure represent the mapping for onset GS i.e. the growth stage recorded on the day of disease start, the left panel of the plot represents the onset days after planting i.e. the day difference between crop establishment date and disease start date. The intensity of the onset GS value and the onset days after planting were captured by a color map. The inset histogram represents the distribution of each of the variables considered. The locations in gray represent no disease scenario, the locations with forest green crosses represent locations where a disease was predicted post-harvest.

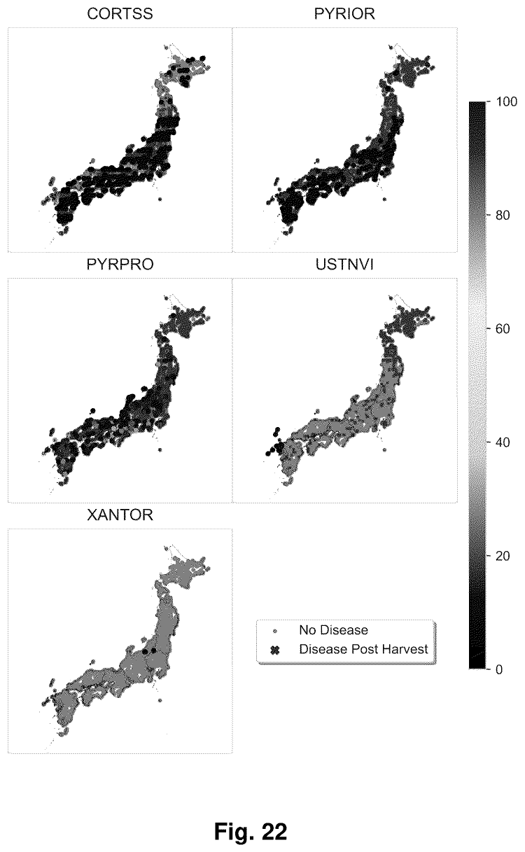

The maximum predicted disease severity for all rice growing location in Japan is geo-spatially represented in FIG. 22, which shows the geo-spatial distribution of maximum severity predicted by the trained models for sheath blight (CORTSS), leaf blast (PYRIOR), panicle-neck blast (PYRPRO), bacterial leaf blight (XANTOR) & false smut (USTNVI) for all locations with disease occurrence.

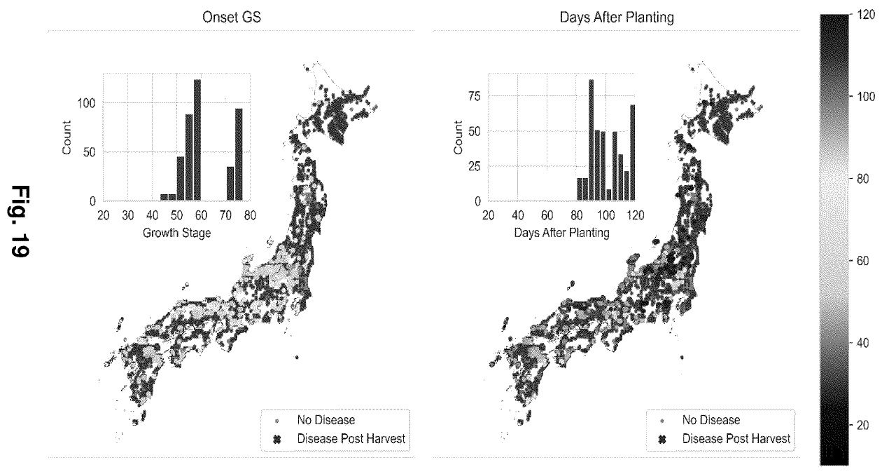

For sheath blight, it can be observed in FIG. 17 that the onset growth stage i.e. the growth stage recorded on the day of disease start is often near to 21. It can also be observed that this disease is commonly predicted in central Japan. For leaf blast, the geo-spatial representation of onset growth stage and onset days after planting is represented in 18. It can be observed that it almost predicted at all parts of Japan and it is usually predicted to have an onset at an early growth stage. For panicle-neck blast, it can be observed in FIG. 19 that the onset growth stage is often near to growth stage 70-80. It is predicted to occur late during the crop cycle. False smut disease is predicted to be more common in south Japan and the onset of the disease is also predicted to be at a later stage of crop cycle i.e. at growth stages 70-80 like panicle-neck blast. We however predict no locations with an infestation of bacterial leaf blight for the rice growing locations in Japan. The geo-spatial representation of maximum disease severity, represented in FIG. 22, suggests that the predicted maximum severity recorded for most diseases is in range of 20-40.

### 5.2 Secondary Infection Determination Module

### 5.2.1 Process-Based Model in Simulating Secondary Disease Infection

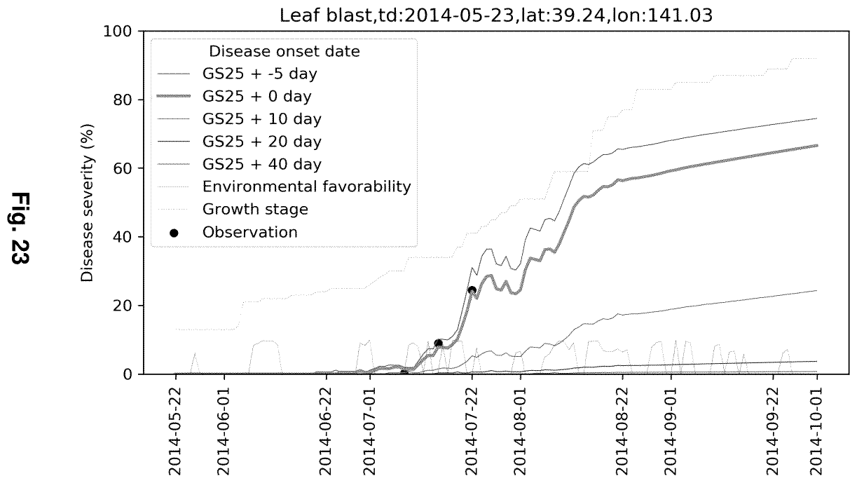

FIG. 23 shows the effects of disease onset date on the disease progress curve.

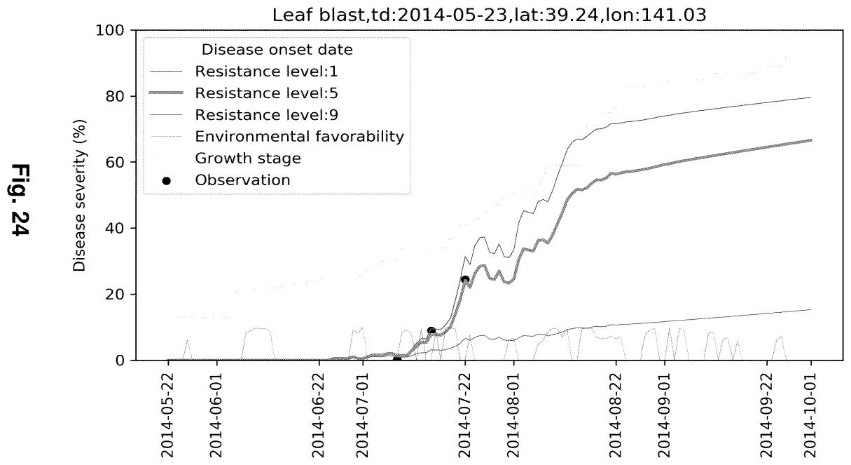

FIG. 24 shows the effects of variety disease resistance level on the disease progress curve. The resistance level here is ranked from 1 to 9. 1 is susceptible, 9 is resistance.

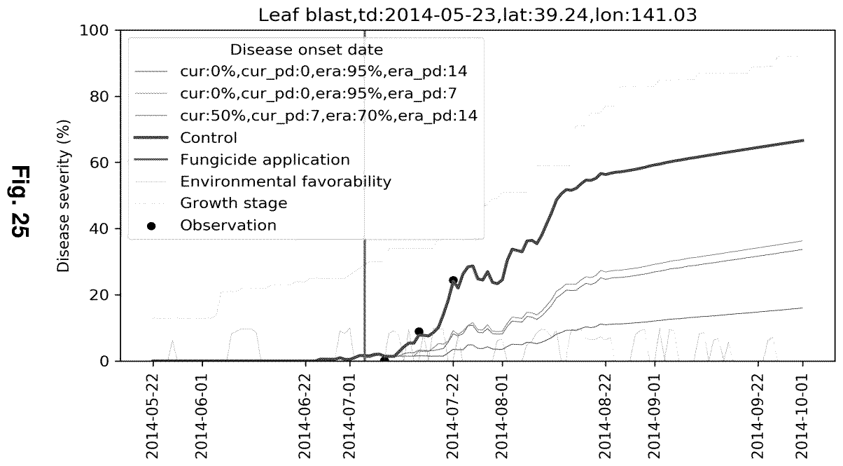

FIG. 25 shows the effects of fungicide applications on the disease progress curve. Cur indicate the curative efficacy, cur_pd indicates the curative protection days, era indicates eradicant efficacy, era_pd indicate the eradicant protection days.

Predicting the disease onset and disease progress curves to characterize disease progress over time is essential for understanding how plant diseases develop and how disease control measures should be taken to achieve the highest efficacy of fungicide. As discussed above, we propose a ML based model to simulated disease onset and use process-based model to simulate the disease progress curve and the effects of weather condition, growth stage, variety and fungicide spray. The ML achieve a high accuracy in simulating the disease starting date and the process-based model can reflect the response of disease to the most important factors.

Turning to FIG. 1, the determined disease progression is provided via the output unit 18. The determined disease progression is preferably usable for fungicide spray schedule on an agricultural field.

Optionally, as shown in FIG. 1, the apparatus 10 may further comprise a fungicide spray schedule determination module 20 configured to determining, based on the determined disease progress, a fungicide spray schedule. The fungicide spray schedule may be determined based on the analysis of the effects of fungicide applications on the disease progress curve, such as the curve shown in FIG. 25. In this way, spray timing is set with considering the changes in disease dynamics, leading to improved treatments. In other words, spray timing is based on the predicted risk of disease, allowing to apply fungicides when they are most effective during the growing season. In particular, the determined fungicide spray schedule may target the optimal application periods better to halt disease progress, with less chance of missing the risk periods. Consequently, the optimized spray timing may have a considerable effect on the overall reduction in fungicide use.

The fungicide spray schedule may comprise application timing data. Based on the fungicide spray schedule, a configuration file may be generated. The configuration file may be usable for configuring a sprayer for applying fungicide spray to the agricultural field in accordance with the application timing data.

FIG. 26 shows a fungal disease management system 100, which may be a cloud environment. As shown, the fungal disease management system 100 comprises one or more data sources 110, a data analysis server 120, an electronic communication device 130, a network 140, and a sprayer 150. In this example, the apparatus 10 shown in FIG. 1 is embodied in the data analysis server 120, e.g., residing in the data analysis server 120 as a software.

The data sources 110 of the illustrate example may include databases, applications, local files, or any combination thereof. The data sources 110 may include data obtained from one or more sources. For example, the data sources 110 may comprise crop variety data obtained from the field data of the agricultural field, environmental data obtained from sensors deployed in the field and/or from a weather forecasting service, crop management data obtained from a data management system, and location data from the field data of the agricultural field.

The data analysis server 120 of the illustrated example may be a server that provides a web service to facilitate management of data. The data analysis server 120 may comprise a data extraction module (not shown) configured to identify data in the data sources 110 that is to be extracted, retrieve the data from the data sources, and provide the retrieved data to the apparatus 10, which processes the extracted data according to the method as described herein. The processed data is then provided to a data analysis application residing in the electronic communication device 130 so that the data may be displayed and manipulated by a user. In some examples, the apparatus 10 may provide fungicide spray schedule, which may be provided to the electronic communication device 130 to allow the farmer to configure the sprayer 150 according to the fungicide spray schedule. In some examples, the apparatus 10 may provide a configuration profile, which may be loaded to the sprayer 150 to configure the sprayer 150 to apply the fungicides according to the determined spray timing.

The electronic communication device 130 of the illustrated example may be a desktop, a notebook, a laptop, a mobile phone, a smart phone and/or a PDA. The electronic communication device 130 may comprises a data analysis application, which may be a software application that enables a user to manipulate data extracted from the data sources 110 by the data analysis server 120 and to select and specify actions to be performed on the individual data. For example, the data analysis application may be a desktop application, a mobile application, or a web-based application. The data analysis application may comprise a user interface, such as an interactive interface including, but not limited to, a GUI, a character user interface and a touch screen interface. Via the software application, the user may access the data analysis server 120 to obtain information like disease onset data, infection rate of the fungal disease after the disease onset day, fungicide spray schedule, and/or configuration file usable for configuring the sprayer 150.

The sprayer 150 may be e.g. ground robots with variable-rate applicators, aerial sprayers, or other variable-rate applicators for applying a fungicide to the agricultural area. In the example of FIG. 26, the sprayer 150 may be smart farming machinery. The smart farming machinery may be a smart sprayer and includes a connectivity system 152. The connectivity system 152 may be configured to communicatively couple the smart farming machinery 150 to the computing environment.

The network 140 of the illustrated example communicatively couples the data sources 110, the data analysis server 120, the electronic communication device 130, and the sprayer 150. In some examples, the network 140 may be the internet. Alternatively, the network 140 may be any other type and number of networks. For example, the network 140 may be implemented by several local area networks connected to a wide area network. For example, the data sources 110 may be associated with a first local area network, the data analysis server 120 may be associated with a second local area network, and the electronic communication device 130 may be associated with a third local area network. The first, second, and third local area networks may be connected to a wide area network. Of course, any other configuration and topology may be utilized to implement the network 140, including any combination of wired network, wireless networks, wide area networks, local area networks, etc.

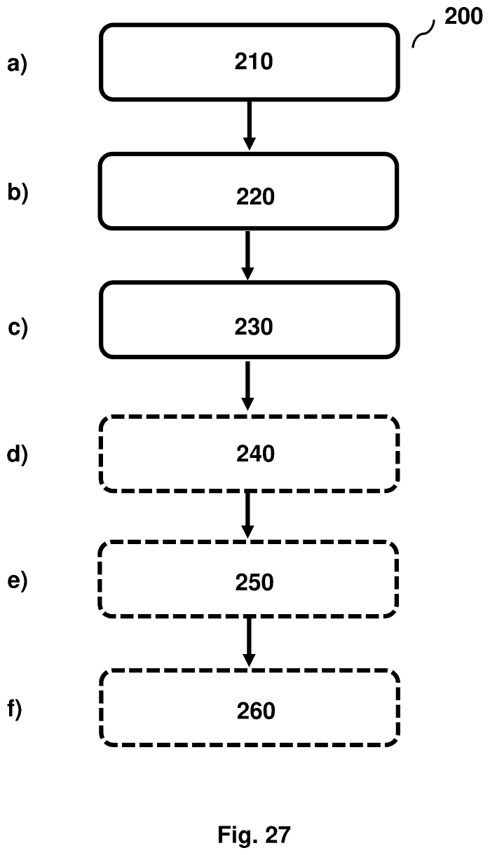

FIG. 27 illustrates a flow chart illustrating a computer-implemented method 200 for determining a disease progression usable for fungicide spray schedule on an agricultural field. The method may be understood to underline operation of the above mentioned apparatus 10. However, it will be also understood that the method steps explained in FIG. 27 are not necessarily tied to the architecture of the apparatus 10 as described above in relation to FIG. 1. More particularly, the method described below may be understood as teachings in their own right.

At block 210, i.e. step a), data is received e.g., by the exemplary apparatus 10 shown in FIG. 1 or FIG. 26. The received data comprises crop variety data, environmental data, crop management data, and location data of the agricultural field.

The crop variety data relates to a crop grown or to be grown on an agricultural field. Exemplary crop variety data may include, but is not limited to, growth stage at a specific time point, crop density (i.e. number of crops present per unit area of the field), and days after plantation. The crop variety data may be obtained from the field data of the agricultural field.

The environmental data is indicative of an environmental condition for the agricultural field. Exemplary environmental data may include, but is not limited to, air temperature, cloud cover, dew point, short wave radiation, long wave radiation, ice accumulation period, liquid accumulation period, relative humidity, precipitation accumulation period adjusted, snow accumulation period, wind speed. In some examples, the environmental data may be collected by sensors deployed on the agricultural field. In some examples, the environmental data may be received from a weather forecasting service.

The crop management data indicative of fungicide spray history for the agricultural field. The crop management data may be obtained from a data management system that stores the fungicide spray history for the agricultural field.

The location data of the agricultural field may include latitude and longitude data (e.g., decimal degrees, negative values for south or west) of the agricultural field, which may be obtained from the field data of the agricultural field.

At block 220, i.e. step b), a machine-learning model is applied to the received data to determine disease progression time-series data of a fungal disease. The machine-learning model has been trained to learn the disease progression under a condition defined by crop variety data, environmental data, crop management data, and location data based on historic data collected from one or more agricultural fields.

The machine-learning model may be any appropriate model capable of determining disease progression time series data of a fungal disease. Examples of the machine-learning model may include, but are not limited to, XGB regression model, Artificial Neural Network, and Support Vector Regression.

An exemplary machine-learning model, XGB regression model, is discussed in detail above and in particular in section 2 “primary infection determination module”.

In some examples, a plurality of machine-learning models are provided for two or more fungal diseases. Each machine-learning model has been trained for a single disease.

At block 230, i.e., step c), based on the determined disease progression time-series data, a disease onset date of the fungal disease is determined. For example, the disease onset date of the fungal disease is determined utilizing a change point detection algorithm.

As an optional step, at block 240, i.e., step d), a process-based model may be applied to determine an infection rate of the fungal disease after the disease onset day under a condition defined by the crop variety data, the environmental data, the crop management data, and the location data. The process-based model may comprise an SEIR model. In some examples, the infection rate of the fungal disease may be determined by further including a condition defined by a variety disease resistance level of the crop.

As a further optional step, at block 250, i.e., step e), a fungicide spray schedule may be determined based on the determined disease progress. The fungicide spray schedule may be determined based on the analysis of the effects of fungicide applications on the disease progress curve, such as the curve shown in FIG. 25. In this way, spray timing is set with considering the changes in disease dynamics, leading to improved treatments.

As a still further optional step, at block 260, i.e., step f), a configuration file is generated based on the fungicide spray schedule, which is preferably usable for configuring a sprayer for fungicide spray application.

It will be appreciated that the above operation may be performed in any suitable order, e.g., consecutively, simultaneously, or a combination thereof, subject to, where applicable, a particular order being necessitated, e.g., by input/output relations.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” In other words, the indefinite article “a” or “an” does not exclude a plurality.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A computer-implemented method for determining a disease progression usable for fungicide spray schedule on an agricultural field, the method comprising:
a) receiving data including:
crop variety data relating to a crop grown or to be grown on an agricultural field;
environmental data indicative of an environmental condition for the agricultural field;
crop management data indicative of fungicide spray history for the agricultural field; and
location data of the agricultural field;
b) applying a machine-learning model to the received data to determine disease progression time-series data of a fungal disease, wherein the machine-learning model has been trained to learn the disease progression under a condition defined by crop variety data, environmental data, crop management data, and location data based on historic data collected from one or more agricultural fields; and
c) determining, based on the determined disease progression time-series data, a disease onset date of the fungal disease.

2. The computer-implemented method according to claim 1,
wherein the disease onset date of the fungal disease is determined utilizing a change point detection algorithm.

3. The computer-implemented method according to claim 1,
wherein a plurality of machine-learning models are provided for two or more fungal diseases, and each machine-learning model has been trained for a single disease.

4. The computer-implemented method according to claim 1,
wherein the machine-learning model comprises an Xtreme Gradient Boosting, XGB, regression model.

5. The computer-implemented method according to claim 1, further comprising:
d) applying a process-based model to determine an infection rate of the fungal disease after the disease onset day under a condition defined by the crop variety data, the environmental data, the crop management data, and the location data.

6. The computer-implemented method according to claim 5,
wherein the infection rate of the fungal disease is determined by further including a condition defined by a variety disease resistance level of the crop.

7. The computer-implemented method according to claim 5,
wherein the infection rate of the fungal disease is determined by further including a condition defined by fungicide application data including fungicide data of a fungicide product to be used and at least one planned application timing.

8. The computer-implemented method according to claim 5,
wherein the process-based model comprises a susceptible-exposed-infections-removed, SEIR, model.

9. The computer-implemented method according to claim 1,
wherein the crop variety data comprises one or more of growth stage of the crop, days after plantation, and/or a variety disease resistance level of the crop.

10. The computer-implemented method according to claim 1,
wherein the environmental data comprises one or more of air temperature, cloud cover, short ware radiation, long wave radiation, ice accumulation period, liquid accumulation period, relative humidity, precipitation accumulation period adjusted, snow accumulation period, and/or wind speed.

11. The computer-implemented method according to claim 1,
wherein the location data comprises latitude and longitude data.

12. The computer-implemented method according to claim 1, further comprising:
e) determining, based on the determined disease progress, a fungicide spray schedule.

13. The computer-implemented method according to claim 1, further comprising:
f) generating, based on the fungicide spray schedule, a configuration file usable for configuring a sprayer for fungicide spray application.

14. An apparatus for generating a disease progression usable for fungicide spray schedule on an agricultural field, the apparatus comprising one or more processing units to generate an application scheme, wherein the one or more processing units include instructions, which when executed on the one or more processing units, perform the method steps of claim 1.

15. A computer program element comprising instructions to cause an apparatus to execute the steps of method of claim 1, wherein the apparatus comprises one or more processing units to generate an application scheme, wherein the one or more processing units include instructions, which when executed on the one or more processing units, perform the method steps of claim 1.
